(19) United States
(12) Patent Application Publication
(10) Pub. No.: US 2025/0334504 A1
(43) Pub. Date: Oct. 30, 2025

(54) PARTICLE SORTING SYSTEM, PARTICLE SORTING METHOD, AND PARTICLE SORTING PROGRAM

(71) Applicant: SONY GROUP CORPORATION, TOKYO (JP)

(72) Inventor: KENSAKU TAKAHASHI, TOKYO (JP)

(21) Appl. No.: 18/871,562

(22) PCT Filed: Jun. 1, 2023
(86) PCT No.: PCT/JP2023/020531

§ 371 Date: Dec. 4, 2024

(30) Foreign Application Priority Data
Jun. 14, 2022 (JP) 2022-096049

(51) Int. Cl. G01N 15/149

(52) U.S. Cl. CPC G01N 15/149

(57) ABSTRACT

To provide a technology for more accurately specifying a timing from detection of light from a particle to start of sorting processing, according to the particle, in a particle sorting technology.

Provided is a particle sorting system including: a detection unit that detects light from a particle contained in a fluid; and a processing unit that specifies a delay time from detection by the detection unit to start of sorting processing, in which the processing unit specifies, on the basis of a relationship between an intensity of scattered light and a delay time associated with a particle size, the delay time from an intensity of scattered light detected by the detection unit.

### TECHNICAL FIELD

The present technology relates to a particle sorting system. More specifically, the present technology relates to a particle sorting system, a particle sorting method, and a particle sorting program that perform sorting of particles contained in a fluid.

### BACKGROUND ART

In recent years, along with development of analytical methods, a method is being developed in which biological microparticles such as cells and microorganisms and microparticles such as microbeads and the like are caused to flow through a flow path, and the particles and the like are individually detected and the detected particles and the like are analyzed or sorted in a step of causing the particles to flow.

As a representative example of such a method for analysis or sorting of the particles, technological improvement of an analytical method referred to as flow cytometry is advancing rapidly. Flow cytometry is an analytical method of performing analysis and sorting of the particles by causing the particles to be analyzed to flow in a state arrayed in a fluid and irradiating the particles with laser light and the like to detect fluorescence and scattered light emitted from each of the particles.

For example, in a case where fluorescence of a cell is detected, a cell labeled with a fluorescent dye is irradiated with excitation light having an appropriate wavelength and intensity, such as laser light. Then, fluorescence emitted from the fluorescent dye is collected by a lens or the like, light in an appropriate wavelength region is selected with use of a wavelength selection element such as a filter or a dichroic mirror, and the selected light is detected with use of a light receiving element such as a photo multiplier tube (PMT). At this time, it is also possible to simultaneously detect and analyze beams of fluorescence from a plurality of fluorescent dyes labeled on cells, by combining a plurality of wavelength selection elements and light receiving elements. Moreover, it is also possible to increase the number of fluorescent dyes that can be analyzed, by combining beams of excitation light of a plurality of wavelengths.

For fluorescence detection in flow cytometry, in addition to a method of selecting a plurality of beams of light in discontinuous wavelength regions with use of a wavelength selection element such as a filter and measuring intensity of light in each wavelength region, there is also a method of measuring intensity of light in continuous wavelength regions as a fluorescence spectrum. In spectral flow cytometry capable of measuring a fluorescence spectrum, spectroscopy is performed of fluorescence emitted from a particle with use of a spectroscopic element such as a prism or a grating. Then, the fluorescence subjected to spectroscopy is detected with use of a light receiving element array in which a plurality of light receiving elements having different detection wavelength regions is arranged. For the light receiving element array, there is used a PMT array or a photodiode array in which light receiving elements such as PMTs or photodiodes are one-dimensionally arranged, or an array in which a plurality of independent detection channels is arranged such as two-dimensional light receiving elements, such as a CCD or a CMOS.

In analysis of particles represented by flow cytometry and the like, an optical method is often used that irradiates a particle to be analyzed with light such as laser, and detects fluorescence or scattered light emitted from the particle. Then, on the basis of detected optical information, a histogram is extracted by an analysis computer and software, and analysis is performed.

For example, Patent Document 1 proposes a device for sorting biological particles contained in a liquid flow, the device including: an optical mechanism that irradiates each of biological particles with light to detect light from the biological particles; a control unit that detects a movement speed of the biological particles in the liquid flow on the basis of the light from each of the biological particles; and a charging unit that gives charge to the biological particles on the basis of the movement speed of each of the biological particles.

Furthermore, Patent Document 2 discloses a microparticle sorting device including: a detection unit that detects a microparticle flowing through a flow path; an imaging element that images a droplet containing the microparticle discharged from an orifice provided at an end portion of the flow path; a charging unit that gives charge to the droplet; and a control unit that determines, as a delay time, a time from a time when the microparticle is detected by the detection unit to a time when the number of bright spots in a reference region set in advance in image information imaged by the imaging element is maximized, and enables the charging unit to give a charge to the microparticle after the delay time has elapsed since the microparticle is detected by the detection unit. The microparticle sorting device can automatically, simply, and accurately control an accurate timing at which charge should be given to a droplet containing a microparticle.

### CITATION LIST

### Patent Document

Patent Document 1: Japanese Patent Application Laid-Open No. 2009-145213

Patent Document 2: Japanese Patent Application Laid-Open No. 2013-210264

### SUMMARY OF THE INVENTION

### Problems to be Solved by the Invention

As described above, in particle sorting technology, a technology for controlling the timing from the detection of light from a particle to the start of sorting processing is being developed. However, there are various forms of a particle in the fluid, and there has been a demand for further development of a technology for accurately controlling the timing from the detection of light from the particle to the start of the sorting processing in the particle of various forms.

Thus, a main object of the present technology is to provide a technology for more accurately specifying a timing from the detection of light from a particle to the start of sorting processing, according to the particle in the particle sorting technology.

### Solutions to Problems

The present technology first provides a particle sorting system including: a detection unit that detects light from a particle contained in a fluid; and a processing unit that specifies a delay time from detection by the detection unit to start of sorting processing, in which the processing unit specifies, on the basis of a relationship between an intensity of scattered light and a delay time associated with a particle size, the delay time from an intensity of scattered light detected by the detection unit.

In the present technology, the start of the sorting processing can be charging to a droplet containing the particle or application to an actuator for changing a pressure in a sorting flow path into which the fluid is divided and flows.

In the present technology, the relationship can be an approximate expression indicating a relationship between the intensity of the scattered light and the delay time obtained from particles having different sizes.

The particle sorting system according to the present technology can include a storage unit that stores the relationship.

In the present technology, the storage unit can store the relationship set in advance.

Furthermore, the storage unit can also store the relationship set in advance in association with different sorting conditions.

In this case, the sorting conditions can be one or more sorting conditions selected from a flow speed of the particle and an application condition to a vibration element for droplet formation.

At this time, the application condition can be one or more conditions selected from a frequency of a driving voltage, vibration, and intensity.

The processing unit of the particle sorting system according to the present technology can correct the relationship set in advance on the basis of an intensity of scattered light obtained from a particle of at least one type of size.

Furthermore, the processing unit can also specify a relationship between the intensity of the scattered light and the delay time obtained from particles having different sizes.

In the present technology, forward scattered light can be used as the scattered light.

In the present technology, in a case where the start of the sorting processing is charging to a droplet containing the particle, the particle sorting system according to the present technology can include a droplet imaging unit that images a state of a fluid stream containing the droplet.

In this case, the delay time can be a time from when the particle is detected by the detection unit to when the particle reaches a position of a break-off point, and
the break-off point can be specified on the basis of a fluid stream image captured by the droplet imaging unit.

The present technology next provides a particle sorting method including:
a detection step of detecting light from a particle contained in a fluid; and
a processing step of specifying a delay time from detection in the detection step to start of sorting processing, in which
in the processing step, on the basis of a relationship between an intensity of scattered light and a delay time associated with a particle size, the delay time is specified from an intensity of scattered light detected by the detection unit.

The present technology further provides a particle sorting program for causing a computer to implement a processing function of specifying, on the basis of a relationship between an intensity of scattered light and a delay time associated with a particle size, from an intensity of scattered light detected from a particle contained in a fluid, a delay time from detection of the scattered light to start of sorting processing.

### BRIEF DESCRIPTION OF DRAWINGS

FIG. 1 is a schematic conceptual diagram schematically illustrating a first embodiment of a particle sorting system 1 according to the present technology.

FIG. 2 is a schematic conceptual diagram schematically illustrating a second embodiment of the particle sorting system 1 according to the present technology.

FIG. 3 is a schematic conceptual diagram schematically illustrating a third embodiment of the particle sorting system 1 according to the present technology.

FIG. 4 is a schematic conceptual diagram schematically illustrating a fourth embodiment of the particle sorting system 1 according to the present technology.

FIG. 5 is a schematic conceptual diagram illustrating an installation example of a vibration element V and a charging unit 103a.

FIG. 6 is a schematic conceptual diagram in which a substrate T portion is enlarged on which a flow path P of the particle sorting system 1 according to the third embodiment illustrated in FIG. 3 is formed.

FIG. 7 is a photograph in which particles having different sizes (large, small) are caused to flow, and particle positions at a certain time are captured by fluorescence observation.

FIG. 8 is a graph illustrating a distribution density of white blood cells by scattered light.

FIG. 9 is a graph illustrating a relationship between forward scattered light and a bead size (μm) detected when beads of different sizes are caused to flow.

FIG. 10 is a graph in which beads of different sizes (φ10 μm, φ24.4 μm) are caused to flow, and forward scattered light and an arrival time to a sorting position are plotted.

FIG. 11 is a flowchart of particle sorting in a case where the particle sorting system 1 according to the first embodiment illustrated in FIG. 1, the second embodiment illustrated in FIG. 2, and the fourth embodiment illustrated in FIG. 4 is used.

FIG. 12 is a flowchart of particle sorting in a case where the particle sorting system 1 according to the first embodiment illustrated in FIG. 1, the second embodiment illustrated in FIG. 2, and the fourth embodiment illustrated in FIG. 4 is used.

FIG. 13 is a graph illustrating an intensity distribution of forward scattered light of cells used in an example.

FIG. 14 is a graph illustrating an intensity distribution of forward scattered light of cells used in an example.

FIG. 15 is a graph illustrating a relationship between a sorting collection rate and Phase, of cells X and Y.

### MODE FOR CARRYING OUT THE INVENTION

Hereinafter, preferred embodiments for carrying out the present technology will be described with reference to the drawings. The embodiments to be described below are intended to illustrate examples of representative embodiments of the present technology, and the scope of the present technology will not be construed narrower by these embodiments. Note that the description will be made in the following order.

### 1. Particle Sorting System 1

(1) Flow path P
(2) Light irradiation unit 101
(3) Detection unit 102
(4) Sorting mechanism 103
(5) Processing unit 104
(6) Control unit 105
(7) Droplet imaging unit 106
(8) Storage unit 107
(9) Display unit 108
(10) User interface 109
   2. Particle sorting method
   3. Particle sorting program

### 1. Particle Sorting System 1

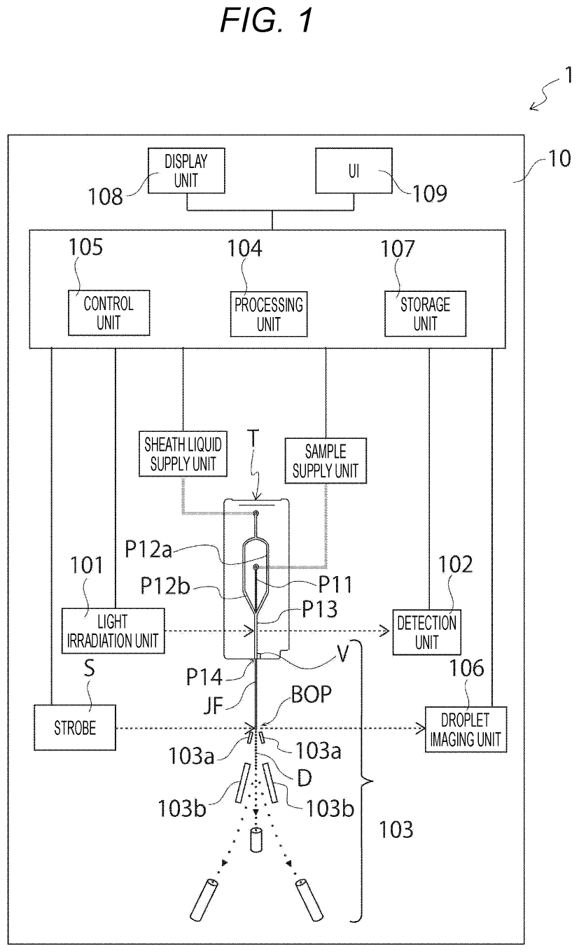

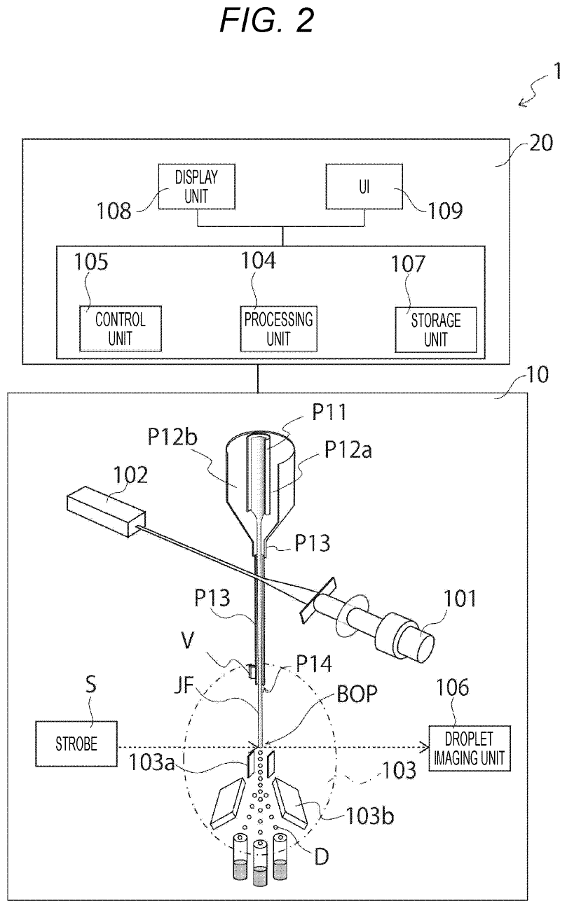

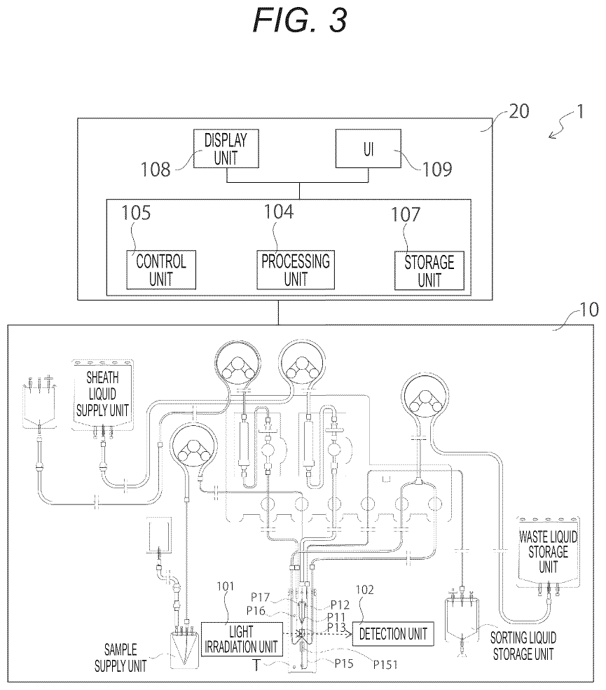

FIG. 1 is a schematic conceptual diagram schematically illustrating a first embodiment of a particle sorting system 1 according to the present technology. FIG. 2 is a schematic conceptual diagram schematically illustrating a second embodiment of the particle sorting system 1 according to the present technology. FIG. 3 is a schematic conceptual diagram schematically illustrating a third embodiment of the particle sorting system 1 according to the present technology. The particle sorting system 1 according to the present technology includes at least a detection unit 102 and a processing unit 104. Furthermore, as necessary, a flow path P (P11 to 13), a light irradiation unit 101, a sorting mechanism 103, a control unit 105, a droplet imaging unit 106, a storage unit 107, a display unit 108, a user interface 109, and the like can be included.

Note that the processing unit 104, the control unit 105, the storage unit 107, the display unit 108, the user interface 109, and the like may be provided in a device 10 that performs sorting of particles as in the first embodiment illustrated in FIG. 1, or it is also possible to make the particle sorting system 1 including: a particle sorting device 10 including the light irradiation unit 101, the detection unit 102, and the sorting mechanism 103; and an information processing device 20 including the processing unit 104, the control unit 105, the storage unit 107, the display unit 108, and the user interface 109, as in the second embodiment illustrated in FIG. 2 and the third embodiment illustrated in FIG. 3.

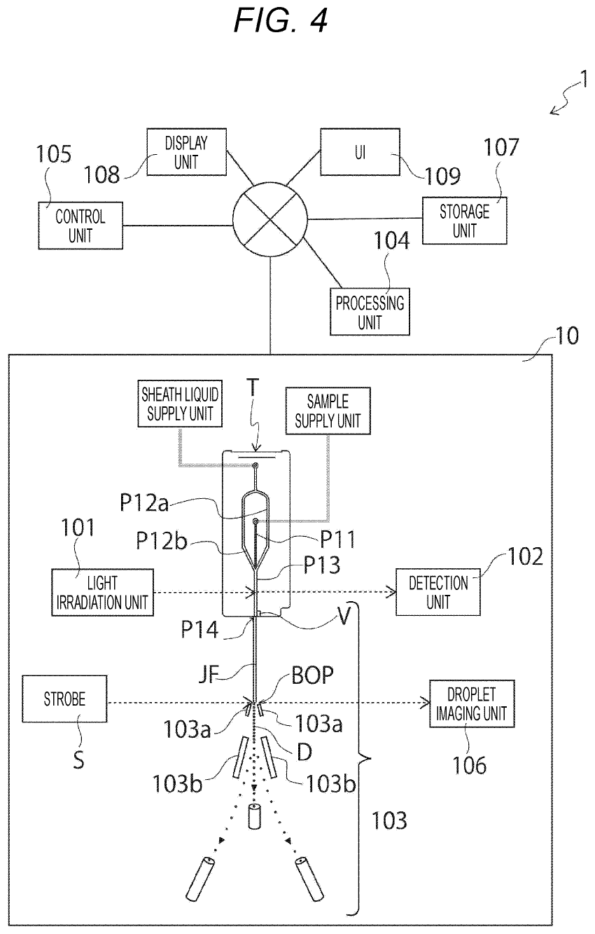

Furthermore, as in the fourth embodiment of the particle sorting system 1 illustrated in FIG. 4, the processing unit 104, the control unit 105, the storage unit 107, the display unit 108, and the user interface 109 can be provided independently, and can be connected to the particle sorting system 1 via a network.

In addition, although not illustrated, the processing unit 104, the control unit 105, the storage unit 107, and the display unit 108 can be provided in a cloud environment and connected to the particle sorting system 1 via a network. Furthermore, although not illustrated, it is also possible to provide the processing unit 104, the control unit 105, the display unit 108, and the user interface 109 in the information processing device 20, and provide the storage unit 107 in a cloud environment to be connected to the particle sorting device 10 and the information processing device 20 via a network. In this case, records and the like of various types of processing in the information processing device 20 can be stored in the storage unit 107 on the cloud, and various types of information stored in the storage unit 107 can be shared by a plurality of users. Hereinafter, details of each unit will be described.
(1) Flow path P

The particle sorting system 1 according to the present technology can perform analysis and sorting of particles by detecting optical information obtained from the particles aligned in one line in a flow cell (flow path P).

While the flow path P may be provided in advance in the particle sorting system 1, it is also possible to install a commercially available flow path P or a disposable chip or the like provided with the flow path P to perform analysis or sorting.

A form of the flow path P is not particularly limited, and can be freely designed. For example, not only the flow path P formed in the substrate T such as two-dimensional or three-dimensional plastic or glass as illustrated in FIGS. 1, 3, and 4, but also the flow path P used in a conventional flow cytometer as in the second embodiment illustrated in FIG. 2 can be used for the particle sorting system 1.

Furthermore, the flow path width, the flow path depth, and the flow path cross-sectional shape of the flow path P are not particularly limited as long as a laminar flow can be formed, and can be freely designed. For example, a micro flow path having a flow path width less than or equal to 1 mm can also be used for the particle sorting system 1. In particular, a micro flow path having a flow path width greater than or equal to 10 um and less than or equal to 1 mm can be suitably used for the present technology.

A method of feeding particles is not particularly limited, and the particles can be caused to flow through the flow path P according to the form of the flow path P to be used. A description will be given of, for example, the case of the flow path P formed in the substrate T illustrated in FIGS. 1, 3, and 4. A sample liquid containing particles is introduced into a sample liquid flow path P11, and a sheath liquid is introduced into two sheath liquid flow paths P12a and P12b. The sample liquid flow path P11 and the sheath liquid flow paths P12a and P12b merge to form a main flow path P13. A sample liquid laminar flow fed in the sample liquid flow path P11 and sheath liquid laminar flows fed in the sheath liquid flow paths P12a and P12b can merge in the main flow path P13 to form a sheath flow in which the sample liquid laminar flow is sandwiched between the sheath liquid laminar flows.

The particles caused to be flow through the flow path P widely include bio-related particles such as cells, microorganisms, and ribosomes, or synthetic particles such as latex particles, gel particles, and industrial particles.

The bio-related particles include chromosomes constituting various cells, ribosomes, mitochondria, organelles (cell organelles) and the like. The cells include animal cells (for example, hemocyte cells and the like) and plant cells. The microorganisms include bacteria such as Escherichia coli, viruses such as tobacco mosaic virus, fungi such as yeast, and the like. Moreover, the bio-related particles can also include bio-related polymers such as nucleic acids, proteins, and complexes thereof. Furthermore, the industrial particles may be, for example, an organic or inorganic polymer material, a metal, or the like. The organic polymer material includes polystyrene, styrene/divinylbenzene, polymethyl methacrylate, and the like. The inorganic polymer material includes glass, silica, a magnetic material, and the like. The metal includes gold colloid, aluminum, and the like. In general, shapes of these particles are normally spherical, but may be non-spherical in the present technology, while the size, mass, and the like thereof are also not particularly limited.

The particles caused to flow through the flow path P can be labeled with one or two or more dyes such as fluorescent dyes. In this case, the fluorescent dyes available in the present technology include, for example, Cascade Blue, Pacific Blue, Fluorescein isothiocyanate (FITC), Phycoerythrin (PE), Propidium iodide (PI), Texas red (TR), Peridinin chlorophyll protein (PerCP), Allophycocyanin (APC), 4′,6-Diamidino-2-phenylindole (DAPI), Cy3, Cy5, Cy7, Brilliant Violet (BV421), and the like.

Note that other flow paths P15, P16, and P17 provided in the particle sorting system 1 according to the third embodiment illustrated in FIG. 3 will be described in the sorting mechanism 103 to be described later.
(2) Light irradiation unit 101

The light irradiation unit 101 irradiates a particle contained in a fluid with excitation light. The light irradiation unit 101 can also include a plurality of light sources so that beams of excitation light having different wavelengths can be emitted. In this case, a plurality of beams of excitation light having different wavelengths can be emitted at positions different in a flow direction of the fluid.

A type of light emitted from the light irradiation unit 101 is not particularly limited, but light having a constant light direction, wavelength, and light intensity is desirable in order to reliably generate fluorescence and scattered light from the particle. A laser, an LED, and the like may be used, for example. In a case where a laser is used, a type of the laser is not particularly limited, and it is possible to freely combine and use one or two or more of an argon ion (Ar) laser, a helium-neon (He-Ne) laser, a dye laser, a krypton (Cr) laser, a semiconductor laser, a solid-state laser obtained by combining the semiconductor laser and a wavelength conversion optical element, and the like.
(3) Detection unit 102

The detection unit 102 detects light from the particle contained in the fluid. Specifically, fluorescence or scattered light emitted from the particle by irradiation with the excitation light is detected, and converted into an electric signal.

In the present technology, a specific photodetection method for a photodetector that can be used for the detection unit 102 is not particularly limited as long as light from the particle can be detected, and a photodetection method used for a known photodetector can be freely selected and adopted. For example, it is possible to freely combine and adopt one or two or more of photodetection methods used in a fluorescence measuring instrument, a scattered light measuring instrument, a transmitted light measuring instrument, a reflected light measuring instrument, a diffracted light measuring instrument, an ultraviolet spectroscopic measuring instrument, an infrared spectroscopic measuring instrument, a Raman spectroscopic measuring instrument, a FRET measuring instrument, a FISH measuring instrument and other various spectrum measuring instruments, a PMT array or a photodiode array in which light receiving elements such as PMTs or photodiodes are one-dimensionally arranged, an array in which a plurality of independent detection channels is arranged such as two-dimensional light receiving elements, such as a CCD or a CMOS, or the like.
(4) Sorting mechanism 103

In the sorting mechanism 103, sorting of particles is performed on the basis of information regarding the particles in the fluid detected by the detection unit 102. For example, on the basis of analysis results such as sizes, forms, internal structures, and the like of the particles analyzed from optical signals detected by the detection unit 102, the sorting of the particles can be performed downstream of the flow path P. Hereinafter, a sorting method is described separately in each embodiment.

### First Embodiment, Second Embodiment, and Fourth Embodiment

In the particle sorting system 1 according to the first embodiment illustrated in FIG. 1, the second embodiment illustrated in FIG. 2, and the fourth embodiment illustrated in FIG. 4, first, a droplet containing the particle is formed by a vibration element V. Specifically, when a fluid containing particles is ejected as a jet flow JF from an orifice P14 of the main flow path P13, a horizontal cross section of the jet flow JF is modulated in synchronization with a frequency of the vibration element V along the vertical direction with application of vibration to the whole or a part of the main flow path P13 with use of the vibration element V vibrating at a predetermined frequency, and a droplet D is separated and generated at a break-off point BOP.

Note that the vibration element V used in the present technology is not particularly limited, and the vibration element V that can be used for a particle sorting device such as a general flow cytometer can be freely selected and used. As an example, a piezo vibration element and the like can be mentioned. Furthermore, by adjusting an amount of liquid fed to the sample liquid flow path P11, the sheath liquid flow paths P12a and P12b, and the main flow path P13, a diameter of a discharge port, a frequency of the vibration element V, and the like, it is possible to adjust a size of the droplet D, and generate the droplet D containing a certain amount of particles.

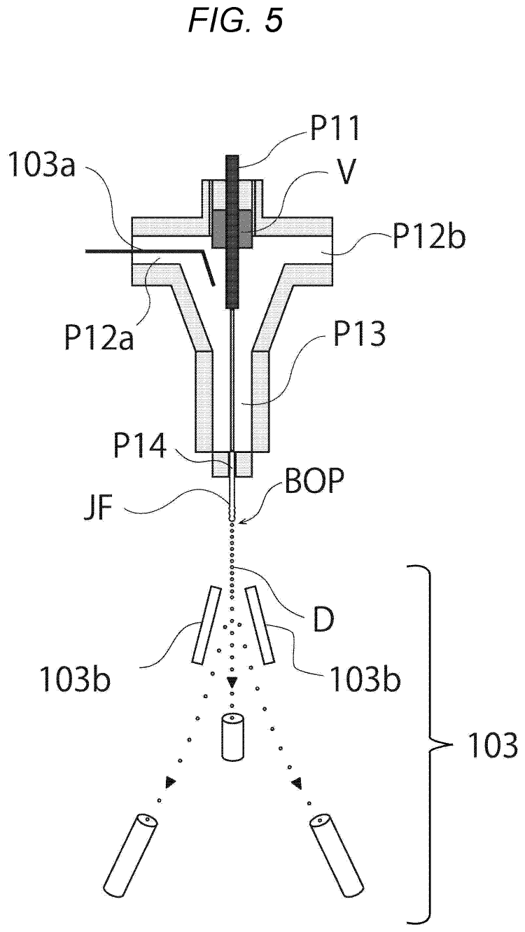

In the present technology, a position of the vibration element V is not particularly limited, and the vibration element V can be freely arranged as long as the droplet containing the particle can be formed. For example, as illustrated in FIGS. 1, 2, and 4, the vibration element V can also be arranged in the vicinity of the orifice P14 of the main flow path P13, or as illustrated in FIG. 5, the vibration element V can also be arranged upstream of the flow path P to apply vibration to the whole or a part of the flow path P or a sheath flow inside the flow path P.

Next, sorting is performed of the droplet D containing the particle formed by the vibration element V. Specifically, the droplet D is charged with a positive or negative charge on the basis of the analysis results such as the sizes, forms, internal structures, and the like of the particles analyzed from the optical signals detected by the detection unit 102 (see a charging unit 103a). Then, the charged droplet D is sorted by changing its course in a desired direction by counter electrodes 103b to which a voltage is applied.

In the present technology, a position of the charging unit 103a is not particularly limited, and can be freely arranged as long as charging can be performed to the droplet D including the particle. For example, as illustrated in FIGS. 1, 2, and 4, charging can be performed directly to the droplet D downstream of the break-off point BOP, or as illustrated in FIG. 5, the charging unit 103a including an electrode or the like can be arranged in the sheath liquid flow path P12a or P12b, and charging can also be performed via the sheath liquid immediately before formation of the droplet D containing a target particle.

### Third Embodiment

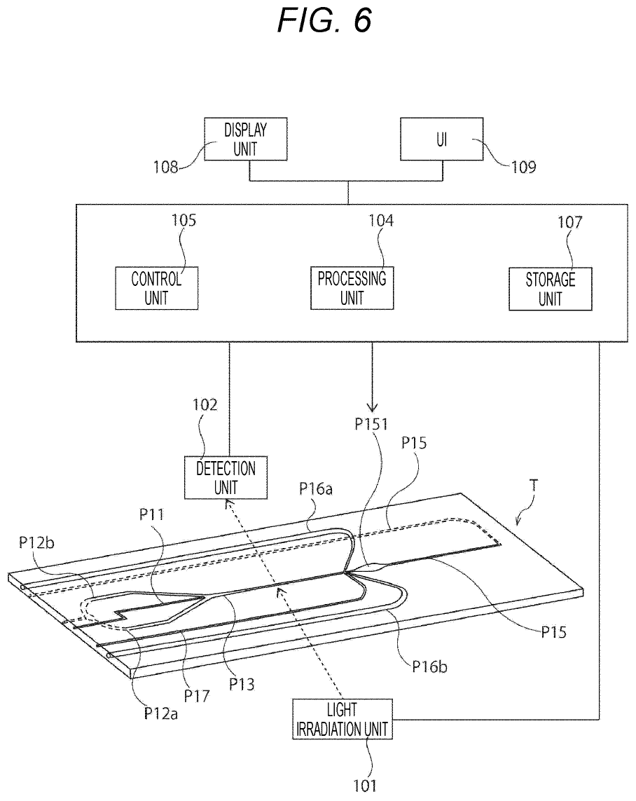

FIG. 6 is a schematic conceptual diagram in which the substrate T portion is enlarged on which the flow paths P of the particle sorting system 1 according to the third embodiment illustrated in FIG. 3 are formed. In the particle sorting system 1 according to the third embodiment illustrated in FIGS. 3 and 6, three branch flow paths of the sorting flow path P15 and waste flow paths P16a and P16b are provided downstream of the main flow path P13 formed in the substrate T, and a particle to be sorted determined to satisfy a predetermined characteristic is taken into the sorting flow path P15, and a particle to be non-sorted determined not to satisfy the predetermined characteristic is caused to flow to one of the two waste flow paths P16a and P16b without being taken into the sorting flow path P15, whereby sorting can be performed.

Taking the particle to be sorted into the sorting flow path P15 can be performed by using a general method, and, for example, can be performed by generating a negative pressure in a pressure chamber P151 provided in the sorting flow path P15 by a piezoelectric device (not illustrated) such as a piezoelectric element, and sucking the sample liquid and the sheath liquid containing the particle to be sorted into the sorting flow path P15 by using the negative pressure. Furthermore, although not illustrated, by controlling or changing a laminar flow direction by using a valve electromagnetic force, a fluid stream (gas or liquid), or the like, it is also possible to take the particle to be sorted into the sorting flow path P15.

The substrate T on which the flow path P of the particle sorting system 1 according to the third embodiment is formed may further include a gate flow path P17 through which a gate liquid flows. The gate path P17 is provided such that one or more gate flow paths P17 are connected, or intersects, for example, perpendicularly, with the sorting flow path P15 from the three branch flow paths of the sorting flow path P15 and the waste flow paths P16a and P16b to just before the pressure chamber P151, for example. The “gate liquid” is a liquid caused to flow through the gate flow path P17 and serves as a main solvent of a sample such as a particle collected after sorting, and thus various liquids can be selected according to applications. For example, in a case where a liquid medium to be used for a particle-containing liquid, the sheath liquid, and the particle are protein, a liquid according to the particle, such as a buffer liquid in which pH and the like is adjusted containing a surfactant, can be caused to flow at a constant flow rate.

In particular, in a case where the particles are cells, a cell culture liquid, a cell preservation liquid, or the like can be used as the gate liquid. In a case where the cell culture liquid is used, it is suitable for a case where a next step is performed on the cells collected after sorting, for example, steps such as cell culture, cell activation, and gene introduction. In a case where a cell preservation liquid is used, it is suitable for a case where collected cells are stored and transported. Furthermore, in a case where the cells to be sorted and collected are undifferentiated cells such as iPS cells, a differentiation-induction liquid can be used, which makes it possible to efficiently proceed with the next work.

Note that, similarly, various kinds of liquid can be selected as the sheath liquid. In the present specification, a flow formed by the gate liquid is referred to as a “gate flow”.

In the present technology, since a flow rate of a liquid introduced into the gate flow path P17 is smaller than a flow rate of a liquid introduced into the sheath liquid flow paths P12a and P12b, it is economical in a case where an expensive liquid such as the cell culture liquid, the cell preservation liquid, or the differentiation-induction liquid is used only for the gate flow path P17.

Furthermore, the gate flow can also be generated to branch from a sheath liquid flow. For example, the sheath liquid flow paths P12a and P12b are connected to an upstream end of the gate flow path P17, and the sheath liquid flow can be caused to branch to flow also into the gate flow path P17, to form a gate flow. At that time, it is necessary to appropriately design flow path resistance of the gate flow path P17 so that a gate flow rate is an appropriate flow rate.

At a place where the gate flow path P17 and the sorting flow path P15 intersect with each other, a gate flow directed toward the main flow path P13 side and the pressure chamber P151 side is also generated together with a gate flow directed straight in the gate flow path P17. The latter gate flow can prevent a particle (non-target particle) that should not be acquired from entering the pressure chamber P151 side of the sorting flow path P15. The gate flow having flowed through the gate flow path P17 flows out to the sorting flow path P15 and branches into the gate flow toward the main flow path P13 side and the pressure chamber P151 side of the sorting flow path P15. The former gate flow can prevent the non-target particle from entering the pressure chamber P151 side of the sorting flow path P15.

In the particle sorting system 1 according to the third embodiment illustrated in FIG. 3, a completely closed type sorting device can be obtained by connecting a sample supply unit to the sample liquid flow path P11, a sheath liquid supply unit to the sheath liquid flow paths P12a and P12b, a sorting liquid storage unit to the sorting flow path P15, and a waste liquid storage unit to the waste flow path P16 in communication with each other. For example, in a case where a sample to be sorted is a cell or the like for use in a cell preparation or the like, it is preferable to design a sorting device to be a completely closed type like the particle sorting system 1 according to the third embodiment illustrated in FIG. 3 in order to maintain a sterile environment and prevent contamination.
(5) Processing unit 104

In the processing unit 104, specifying is performed of a delay time from detection of light from a particle by the detection unit 102 to start of sorting processing by the sorting mechanism 104. More specifically, the processing unit 104 specifies, on the basis of a relationship between an intensity of scattered light and a delay time associated with a particle size, the delay time from an intensity of scattered light detected by the detection unit 102.

In a conventional technology, in a calibration step before sorting is actually performed, a time from detection of light from a bead by the detection unit 102 to start of the sorting processing by the sorting mechanism 103 is derived with use of a bead of a reference size or the like, and actual sorting is performed in the derived time.

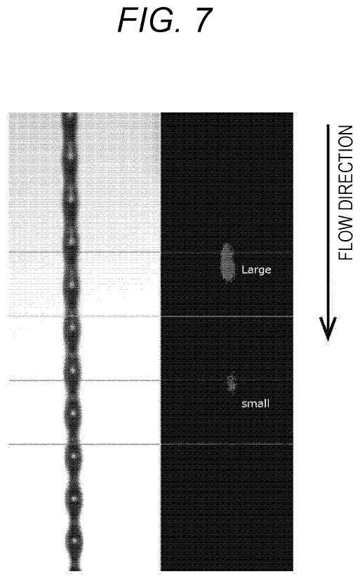

However, there are various forms of a particle in the fluid, and an arrival time from the detection of the light from the particle by the detection unit 102 to a sorting position by the sorting mechanism 103 varies depending on the form of the particle. For example, FIG. 7 is a photograph in which particles having different sizes (large, small) are caused to flow, and particle positions at a certain time are captured by fluorescence observation. As illustrated in the photograph in FIG. 7, it can be seen that a large particle has a slower flow speed than a small particle. Thus, in order to perform sorting with high accuracy, it is a demand to specify a timing at which sorting processing by the sorting mechanism 103 should be started after the light from the particle is detected by the detection unit 102 in accordance with the form of the particle.

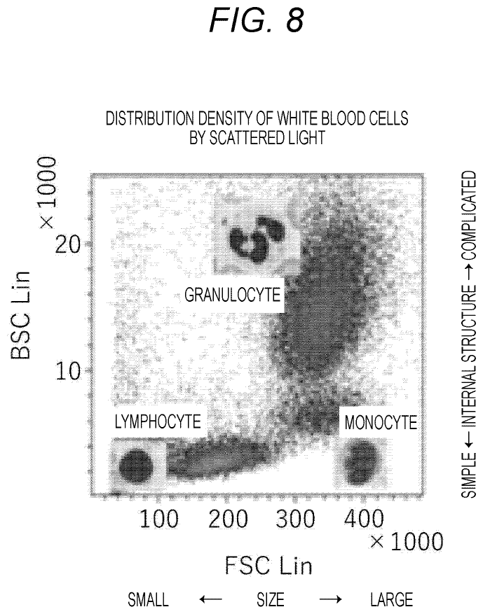

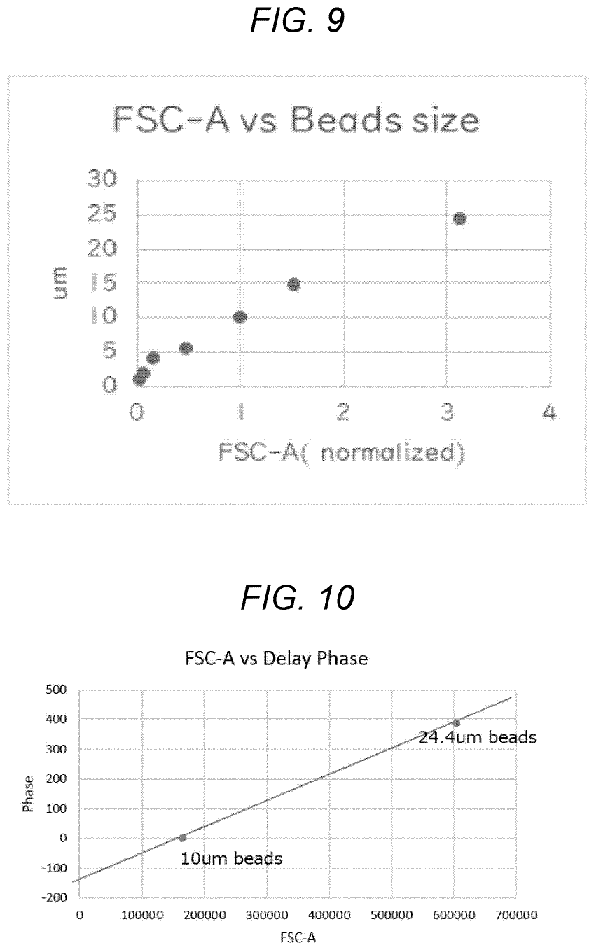

FIG. 8 is a graph illustrating a distribution density of white blood cells by scattered light. FIG. 9 is a graph illustrating a relationship between forward scattered light and a bead size (μm) detected when beads of different sizes are caused to flow. As in the graphs illustrated in FIGS. 8 and 9, the intensity of the scattered light is correlated with the size and internal structure of the particle. Although it is possible to predict the form of the particle from the intensity of the scattered light, the inventor of the present application has found that sorting accuracy is improved by specifying the delay time on the basis of the intensity of the scattered light. That is, if the relationship between the intensity of the scattered light and the delay time associated with the particle size is obtained in advance or in the calibration step, it is possible to specify the delay time optimal for the particle to be sorted by using the intensity of the scattered light detected from the particle to be sorted, on the basis of the relationship.

In the present technology, “start of sorting processing” differs depending on a form of the sorting mechanism 103, and, for example, in the particle sorting system 1 according to the first embodiment illustrated in FIG. 1, the second embodiment illustrated in FIG. 2, and the fourth embodiment illustrated in FIG. 4, can be a time of charging to a droplet containing the particle. Furthermore, the “start of sorting processing” can also be a time for the particle to reach a position of a break-off point.

Furthermore, for example, in the particle sorting system 1 according to the third embodiment illustrated in FIG. 3, the “start of sorting processing” can be a time of application to an actuator for changing a pressure in the sorting flow path P15 into which the fluid is divided and flows. Furthermore, in the third embodiment, in a case where taking the particle to be sorted into the sorting flow path P15 is performed by controlling or changing the laminar flow direction by using the valve electromagnetic force, the fluid stream (gas or liquid), or the like, the “start of sorting processing” can be a time of start of controlling or changing the laminar flow direction.

The relationship between the intensity of the scattered light and the delay time associated with the particle size can be defined by, for example, an approximate expression indicating a relationship between the intensity of the scattered light and the delay time obtained from particles having different sizes. FIG. 10 is a graph in which beads of different sizes (φ10 μm, φ24.4 μm) are caused to flow, and forward scattered light and an arrival time to a sorting position are plotted. As in the graph illustrated in FIG. 10, if a relationship between the forward scattered light and the arrival time to the sorting position is present at two or more points, a straight line can be drawn, so that the relationship between the intensity of the scattered light and the delay time can be defined by such a linear approximate expression. Note that the order of the approximate expression used in the present technology is not particularly limited, and by setting the order to be primary, secondary, tertiary, or higher according to the required sorting accuracy, it is possible to improve the sorting accuracy.

Although the relationship between the intensity of the scattered light and the delay time associated with the particle size can be specified with use of beads or the like having different sizes in the calibration step before sorting is actually performed, a relationship set in advance according to the specification of the particle sorting device 10, a relationship determined at the time of design evaluation of the particle sorting device 10, or the like is stored in the storage unit 107 to be described later, and on the basis of this, it is possible to specify the delay time optimal for the particle to be sorted by using the intensity of the scattered light detected from the particle to be sorted.

Furthermore, the relationship between the intensity of the scattered light and the delay time associated with the particle size can also be set in association with different sorting conditions. Specifically, for example, the relationship between the intensity of the scattered light and the delay time can be set in association with one or more sorting conditions selected from a flow speed of the particle and an application condition to a vibration element for droplet formation. The application condition in this case can be, for example, one or more conditions selected from a frequency of a driving voltage, vibration, and intensity.

In a case where the relationship between the intensity of the scattered light and the delay time associated with the particle size is set in advance, the processing unit 104 can correct the relationship set in advance on the basis of the intensity of the scattered light obtained from a particle of at least one type of size. For example, in the calibration step before sorting is actually performed, the relationship set in advance is corrected on the basis of the intensity of the scattered light obtained from the particle of at least one type of size and a calibration result such as a sorting position arrival time of the particle, whereby the sorting accuracy can be further improved.

In the present technology, the scattered light detected from the particle is not particularly limited as long as the scattered light exhibits intensity associated with the size of the particle. For example, any of forward scattered light, backward scattered light, and side scattered light can be used.
(6) Control unit 105

The particle sorting system 1 according to the present technology can include the control unit 105. The control unit 105 can control the sorting mechanism 103 on the basis of the delay time suitable for the particle to be sorted specified by the processing unit 104.

Specifically, for example, in the case of the particle sorting system 1 according to the first embodiment illustrated in FIG. 1, the second embodiment illustrated in FIG. 2, and the fourth embodiment illustrated in FIG. 4, it is possible to issue a command from the control unit 105 to the charging unit 103a of the sorting mechanism 103 at a timing of the specified delay time to perform charging to the droplet containing the particle. Furthermore, it is also possible to perform control to issue a command from the control unit 105 to the vibration element V of the sorting mechanism 103 at the timing of the specified delay time so that a droplet is formed at a time when the particle reaches the position of the break-off point.

Furthermore, for example, in the case of the particle sorting system 1 according to the third embodiment illustrated in FIGS. 3 and 6, it is possible to issue a command from the control unit 105 to the piezoelectric device (not illustrated) of the sorting mechanism 103 at the timing of the specified delay time, generate a negative pressure in the pressure chamber P151 provided in the sorting flow path P15, and take a fluid containing particles into the sorting flow path P15. Furthermore, at the timing of the specified delay time, by issuing a command from the control unit 105 to a mechanism (not illustrated) that generates a valve electromagnetic force or the like, or a valve or a pump such as a sheath liquid supply mechanism, a sample supply mechanism, or a gate flow supply mechanism, to control or change the laminar flow direction of the fluid flowing through the main flow path P13, it is also possible to take the particle to be sorted into the sorting flow path P15.

Furthermore, the control unit 105 can issue a command to each unit of the particle sorting system 1 to control each unit. For example, the control unit 105 can also issue a command to a valve or a pump such as a sheath liquid supply mechanism, a sample supply mechanism, or a gate flow supply mechanism to control an amount of supply, a flow speed, or the like of each laminar flow, or can also issue a command to the light irradiation unit 101 or the detection unit 102 to control a light irradiation condition or a detection condition. Furthermore, for example, the control unit 105 can also issue a command to the droplet imaging unit 106 or a strobe S to be described later to perform control of an imaging condition and an imaging timing, control of a light emission condition and a light emission timing, and the like.
(7) Droplet imaging unit 106

In the case of the particle sorting system 1 according to the first embodiment illustrated in FIG. 1, the second embodiment illustrated in FIG. 2, and the fourth embodiment illustrated in FIG. 4, the droplet imaging unit 106 can be included. The droplet imaging unit 106 images a state of a fluid stream (hereinafter, also referred to as “the fluid stream”) containing the droplet. The droplet imaging unit 106 is arranged downstream of the detection unit 102.

A specific configuration of the droplet imaging unit 106 is not limited as long as it can image the state of the fluid stream. For example, the configuration is not limited to a configuration including an imaging element such as a CCD camera or a CMOS sensor, and the configuration may be a so-called line sensor or the like in which a plurality of sensors capable of detecting luminance information of light such as a light amount sensor is arranged.

The droplet imaging unit 106 is arranged at a position where the state of the fluid stream can be imaged between the orifice P14 and the counter electrodes 103b to be described later.

A fluid stream image obtained by the droplet imaging unit 106 is analyzed by the processing unit 104. For example, the break-off point can be specified on the basis of the fluid stream image captured by the droplet imaging unit 106. Furthermore, the fluid stream image obtained by the droplet imaging unit 106 is displayed on the display unit 108 such as a display to be described later, and can also be used by the user to confirm a formation status of the droplet and particle information (size, form, interval, and the like) in the fluid stream.

As a light source for imaging the state of the fluid stream in the droplet imaging unit 106, for example, the strobe S can be used. The strobe S can also be controlled by the control unit 105. The strobe S can include an LED for imaging the fluid stream and a laser (for example, a red laser light source) for imaging the fluid stream, and the light source to be used can be switched according to a purpose of detection by the control unit 105. A specific structure of the strobe S is not particularly limited, and one or two or more well-known circuits or elements can be selected and freely combined.
(8) Storage unit 107

The particle sorting system 1 according to the present technology can include the storage unit 107 that stores various data. The storage unit 107 can store, for example, the relationship between the intensity of the scattered light and the delay time associated with the particle size. In the calibration step before sorting is actually performed, it is also possible to store the relationship between the intensity of the scattered light and the delay time associated with the particle size specified by using beads or the like having different sizes in the storage unit 107; however, it is also possible to store in advance a relationship set in advance according to the specification of the particle sorting device 10, a relationship determined at the time of design evaluation of the particle sorting device 10, or the like.

Furthermore, the storage unit 107 can store all data related to particle detection and particle sorting, such as imaging data imaged by the droplet imaging unit 106, optical signal data from particles detected by the detection unit 102, sorting data of particles sorted by the sorting mechanism 103, processing data processed by the processing unit 104, and control data controlled by the control unit 105.

Furthermore, as described above, in the present technology, since the storage unit 107 can be provided in a cloud environment, it is also possible for the users to share various types of information recorded in the storage unit 107 on the cloud via a network.

Note that, in the present technology, the storage unit 107 is not essential, and various data can be stored with use of an external storage device or the like.
(9) Display unit 108

The particle sorting system 1 according to the present technology can include the display unit 108 that displays various data. The display unit 108 can display all data related to particle detection and particle sorting, for example, optical signal data from particles detected by the detection unit 102, sorting data of particles sorted by the sorting mechanism 103, processing data processed by the processing unit 104, control data controlled by the control unit 105, imaging data imaged by the droplet imaging unit 106, and the like.

In the present technology, the display unit 108 is not essential, and an external display device may be connected. As the display unit 108, for example, a display, a printer, or the like can be used.
(10) User interface 109

The particle sorting system 1 according to the present technology can include the user interface 109 that is a portion to be operated by the user. The user can access each unit and each device through the user interface 109 to control each unit and each device.

In the present technology, the user interface 109 is not essential, and an external operating device may be connected. As the user interface 109, for example, a mouse, a keyboard, or the like can be used.

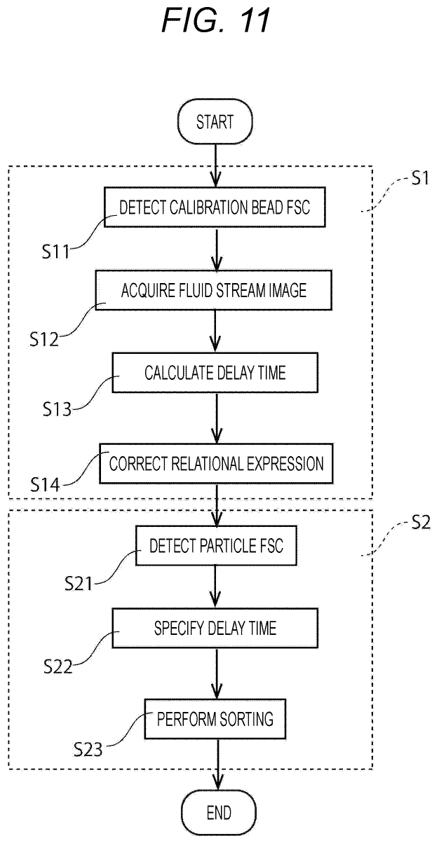

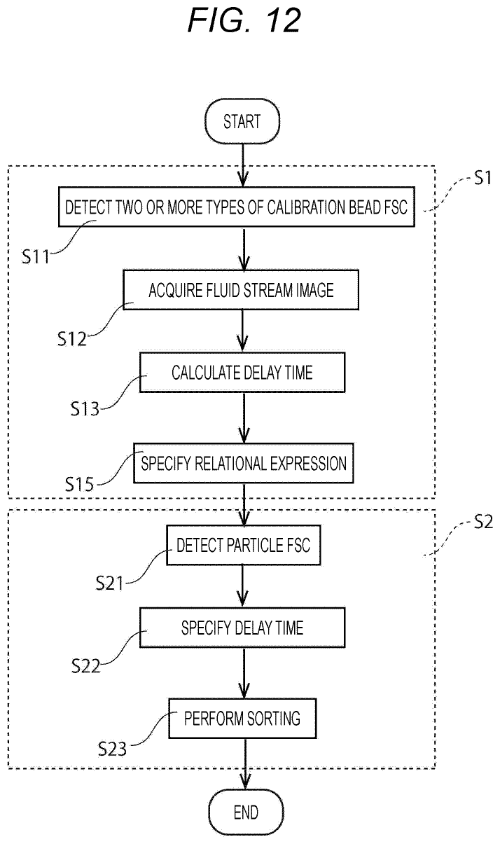

A flow of particle sorting using the particle sorting system 1 according to the present technology described above will be described with reference to FIGS. 11 and 12. FIG. 11 is a flowchart of particle sorting in a case where the particle sorting system 1 according to the first embodiment illustrated in FIG. 1, the second embodiment illustrated in FIG. 2, and the fourth embodiment illustrated in FIG. 4 is used.

The flowchart illustrated in FIG. 11 is a method of correcting a relationship set in advance between the intensity of the scattered light and the delay time associated with the particle size by using a calibration bead or the like in a calibration step S1. First, a calibration bead whose size is known is caused to flow, the calibration bead is irradiated with light with use of the light irradiation unit 101, and scattered light from the calibration bead is detected with use of the detection unit 102 (S11). Next, the fluid stream near the break-off point is imaged with use of the droplet imaging unit 106 (S12). On the basis of the fluid stream image captured by the droplet imaging unit 106, a time (delay time) from when the calibration bead is detected by the detection unit 102 to when the calibration bead reaches the position of the break-off point is calculated (S13). With use of the calculated delay time and the intensity of the scattered light detected by the detection unit 102, a relational expression set in advance is corrected (S14). This completes the calibration step.

Next, particles to be actually sorted are caused to flow, and sorting of target particles are performed (S2). First, a particle is irradiated with light with use of the light irradiation unit 101, and scattered light from the particle is detected with use of the detection unit 102 (S21). The intensity of the scattered light detected by the detection unit 102 is substituted into the relational expression corrected in the calibration step S1, whereby a delay time suitable for the particle is specified (S22). Target particles are sorted on the basis of the specified delay time (S23).

The flowchart illustrated in FIG. 12 is a method of specifying the relationship between the intensity of the scattered light and the delay time associated with the particle size by using two or more types of calibration beads or the like in the calibration step S1. First, two or more types of calibration beads having different sizes are caused to flow, the calibration beads are irradiated with light with use of the light irradiation unit 101, and beams of scattered light from the calibration beads are detected with use of the detection unit 102 (S11). Next, the fluid stream near the break-off point is imaged with use of the droplet imaging unit 106 (S12). On the basis of the fluid stream image captured by the droplet imaging unit 106, a time (delay time) from when the calibration bead is detected by the detection unit 102 to when the calibration bead reaches the position of the break-off point is calculated (S13). With use of the calculated delay time and the intensity of the scattered light detected by the detection unit 102, the relationship between the intensity of the scattered light and the delay time associated with the particle size is specified (S15). This completes the calibration step.

Next, particles to be actually sorted are caused to flow, and sorting of target particles are performed (S2). First, a particle is irradiated with light with use of the light irradiation unit 101, and scattered light from the particle is detected with use of the detection unit 102 (S21). The intensity of the scattered light detected by the detection unit 102 is substituted into the relational expression specified in the calibration step S1, whereby a delay time suitable for the particle is specified (S22). Target particles are sorted on the basis of the specified delay time (S23).

Note that, in the present technology, the calibration step S1 is not an essential step. For example, in a case where the relationship between the intensity of the scattered light and the delay time associated with the particle size is set in advance and there is no need for correction, it is also possible to perform sorting of the target particles (S2) without performing the calibration step S1.

Furthermore, for example, in the case of a completely closed type system as in the particle sorting system 1 according to the third embodiment illustrated in FIG. 3, there is a case where it is difficult to perform the calibration step S1 of causing the calibration beads to flow in advance, and thus, it is also possible to specify a delay time suitable for the particle to be sorted by substituting the intensity of the scattered light of the particle to be extracted detected by the detection unit 102 into a relationship set in advance without performing the calibration step S1, and to perform sorting of the target particles (S2).

### 2. Particle Sorting Method

A particle sorting method according to the present technology includes at least a detection step and a processing step. Furthermore, a light irradiation step, a sorting step, a control step, an imaging step, a storage step, a display step, and the like can be performed as necessary.

Note that since each step is the same as a step performed by a corresponding one of the units of the particle sorting system 1 according to the present technology described above, the description thereof is omitted here.

### 3. Particle Sorting Program

A particle sorting program according to the present technology is a particle sorting program for causing a computer to implement at least a processing function of specifying, on the basis of a relationship between an intensity of scattered light and a delay time associated with a particle size, from an intensity of scattered light detected from a particle contained in a fluid, a delay time from detection of the scattered light to start of sorting processing.

Furthermore, the particle sorting program according to the present technology may be a particle sorting program for causing a computer to implement a control function for controlling each unit of the particle sorting system 1.

The particle sorting program according to the present technology may be stored in a recording medium, for example, a magnetic disk, an optical disk, a magneto-optical disk, or a flash memory, or may be distributed via a network.

Note that since each function is the same as a function performed by a corresponding one of the units of the particle sorting system 1 according to the present technology described above, the description thereof is omitted here.

Note that the present technology can also have the following configurations.
(1)

A particle sorting system including:
a detection unit that detects light from a particle contained in a fluid; and
a processing unit that specifies a delay time from detection by the detection unit to start of sorting processing, in which
the processing unit specifies, on the basis of a relationship between an intensity of scattered light and a delay time associated with a particle size, the delay time from an intensity of scattered light detected by the detection unit.
(2)

The particle sorting system according to (1), in which the start of the sorting processing is charging to a droplet containing the particle or application to an actuator for changing a pressure in a sorting flow path into which the fluid is divided and flows.
(3)

The particle sorting system according to (1) or (2), in which the relationship is an approximate expression indicating a relationship between the intensity of the scattered light and the delay time obtained from particles having different sizes.
(4)

The particle sorting system according to any of (1) to (3), further including a storage unit that stores the relationship.
(5)

The particle sorting system according to (4), in which the storage unit stores the relationship set in advance.
(6)

The particle sorting system according to (4), in which the storage unit stores the relationship set in association with different sorting conditions.
(7)

The particle sorting system according to (6), in which the sorting conditions are one or more sorting conditions selected from a flow speed of the particle and an application condition to a vibration element for droplet formation.
(8)

The sorting system according to (7), in which the application condition is one or more conditions selected from a frequency of a driving voltage, vibration, and intensity.
(9)

The particle sorting system according to (5), in which the processing unit corrects the relationship set in advance on the basis of an intensity of scattered light obtained from a particle of at least one type of size.
(10)

The particle sorting system according to any of (1) to (9), in which the processing unit specifies a relationship between the intensity of the scattered light and the delay time obtained from particles having different sizes.
(11)

The particle sorting system according to any of (1) to (10), in which the scattered light is forward scattered light.
(12)

The particle sorting system according to any of (1) to (11), in which
the start of the sorting processing is charging to a droplet containing the particle, and
the particle sorting system includes a droplet imaging unit that images a state of a fluid stream containing the droplet.
(13)

The particle sorting system according to (12), in which
the delay time indicates a time from when the particle is detected by the detection unit to when the particle reaches a position of a break-off point, and
the break-off point is specified on the basis of a fluid stream image captured by the droplet imaging unit.
(14)

A particle sorting method including:
a detection step of detecting light from a particle contained in a fluid; and
a processing step of specifying a delay time from detection in the detection step to start of sorting processing, in which
in the processing step, on the basis of a relationship between an intensity of scattered light and a delay time associated with a particle size, the delay time is specified from an intensity of scattered light detected by the detection unit.
(15)

A particle sorting program for causing a computer to implement a processing function of specifying, on the basis of a relationship between an intensity of scattered light and a delay time associated with a particle size, from an intensity of scattered light detected from a particle contained in a fluid, a delay time from detection of the scattered light to start of sorting processing.

### Example

Hereinafter, the present technology will be described in more detail on the basis of an example. Note that the example to be described below describes an example of a representative embodiment of the present technology, and the scope of the present technology is not narrowed by the example.

Particles actually handled by the particle sorting system 1 are not only spheres such as beads but also particles having different forms and densities such as cells. Thus, in the present example, it was verified whether the particle sorting system 1 according to the present technology can accurately perform sorting by using cells.

### (1) Method

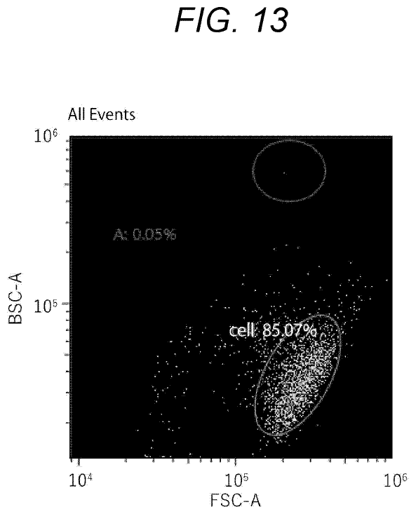

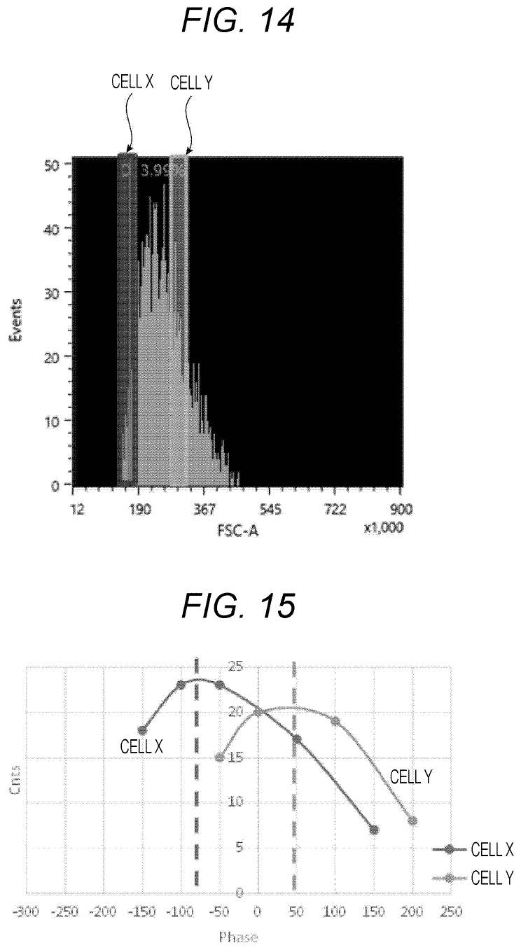

Cells exhibiting forward scattered light with an intensity distribution illustrated in FIG. 13 were used. Gating was performed of cells X exhibiting intensity in a region equivalent to intensity of forward scattered light of beads having a diameter of 10 μm confirmed in advance, and cells Y exhibiting intensity in a region equivalent to intensity of forward scattered light of beads having a diameter of 15 μm confirmed in advance (see FIG. 14). Sorting was performed of the gated cells X and Y with use of different delay times.

### (2) Evaluation

When sorting was performed of the gated cells X and Y with use of different delay times, respective sorting collection rates were calculated.

### (3) Result

FIG. 15 illustrates a result of the sorting collection rates at each delay time of the cells X and Y. As illustrated in FIG. 15, a shift of Phase between the maximum values of the sorting collection rates of the cells X and Y was 100 to 150 deg. On the other hand, a phase difference in a linear approximation graph illustrating a relationship between the forward scattered light and the phase of the beads having a diameter of 10 μm and the beads having a diameter of 15 μm, which had been confirmed in advance, was about 130 deg, which coincided with the shift of Phase between the maximum values of the sorting collection rates of the cells X and Y. From the result, it was proved that even particles having different forms and densities such as cells can be accurately sorted by the particle sorting system 1 according to the present technology.

### Reference Signs List

1 Particle sorting system
10 Particle sorting device
20 Information processing device
P Flow path
P11 Sample liquid flow path
P12a, P12b Sheath liquid flow path
P13 Main flow path
P14 Orifice
P15 Sorting flow path
P16a, P16b Waste flow path
101 Light irradiation unit
102 Detection unit
103 Sorting mechanism
V Vibration element
103a Charging unit
103b Counter electrodes
JF Jet flow
BOP Break-off point
D Droplet
104 Processing unit
105 Control unit
106 Droplet imaging unit
S Strobe
107 Storage unit
108 Display unit
109 User interface

1. A particle sorting system comprising:
a detection unit that detects light from a particle contained in a fluid; and
a processing unit that specifies a delay time from detection by the detection unit to start of sorting processing, wherein
the processing unit specifies, on a basis of a relationship between an intensity of scattered light and a delay time associated with a particle size, the delay time from an intensity of scattered light detected by the detection unit.

2. The particle sorting system according to claim 1, wherein the start of the sorting processing is charging to a droplet containing the particle or application to an actuator for changing a pressure in a sorting flow path into which the fluid is divided and flows.

3. The particle sorting system according to claim 1, wherein the relationship is an approximate expression indicating a relationship between the intensity of the scattered light and the delay time obtained from particles having different sizes.

4. The particle sorting system according to claim 1, further comprising a storage unit that stores the relationship.

5. The particle sorting system according to claim 4, wherein the storage unit stores the relationship set in advance.

6. The particle sorting system according to claim 4, wherein the storage unit stores the relationship set in association with different sorting conditions.

7. The particle sorting system according to claim 6, wherein the sorting conditions are one or more sorting conditions selected from a flow speed of the particle and an application condition to a vibration element for droplet formation.

8. The sorting system according to claim 7, wherein the application condition is one or more conditions selected from a frequency of a driving voltage, vibration, and intensity.

9. The particle sorting system according to claim 5, wherein the processing unit corrects the relationship set in advance on a basis of an intensity of scattered light obtained from a particle of at least one type of size.

10. The particle sorting system according to claim 1, wherein the processing unit specifies a relationship between the intensity of the scattered light and the delay time obtained from particles having different sizes.

11. The particle sorting system according to claim 1, wherein the scattered light is forward scattered light.

12. The particle sorting system according to claim 1, wherein
the start of the sorting processing is charging to a droplet containing the particle, and
the particle sorting system includes a droplet imaging unit that images a state of a fluid stream containing the droplet.

13. The particle sorting system according to claim 12, wherein
the delay time indicates a time from when the particle is detected by the detection unit to when the particle reaches a position of a break-off point, and
the break-off point is specified on a basis of a fluid stream image captured by the droplet imaging unit.

14. A particle sorting method comprising:
a detection step of detecting light from a particle contained in a fluid; and
a processing step of specifying a delay time from detection in the detection step to start of sorting processing, wherein
in the processing step, on a basis of a relationship between an intensity of scattered light and a delay time associated with a particle size, the delay time is specified from an intensity of scattered light detected by the detection unit.

15. A particle sorting program for causing a computer to implement a processing function of specifying, on a basis of a relationship between an intensity of scattered light and a delay time associated with a particle size, from an intensity of scattered light detected from a particle contained in a fluid, a delay time from detection of the scattered light to start of sorting processing.
